(19) United States
(12) Patent Application Publication
(10) Pub. No.: US 2006/0284973 A1
(43) Pub. Date: Dec. 21, 2006

(54) Stereoscopic viewing apparatus

(75) Inventors: Joshua M. Cobb, Victor, NY (US); Mark E. Bridges, Spencerport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/156,119

(22) Filed: Jun. 17, 2005

(51) Int. Cl. H04N 13/04; H04N 15/00

(52) U.S. Cl. 348/51

(57) ABSTRACT

An optical apparatus (10) for stereoscopic viewing has a first optical channel with a first display (12l) generating a first image and a first viewing lens assembly (22l) producing a virtual image, with at least one optical component of the first viewing lens assembly truncated (26l) along a first side. A second optical channel has a second display (12r) generating a second image and a second viewing lens assembly (22r) producing a virtual image, with at least one optical component of the second viewing lens assembly truncated (26r) along a second side. A reflective folding surface is disposed between the second display and second viewing lens assembly to fold a substantial portion of the light within the second optical channel. An edge portion of the reflective folding surface blocks a portion of the light in the first optical channel. The first side of the first viewing assembly is disposed adjacent the second side of the second viewing lens assembly.

### FIELD OF THE INVENTION

This invention generally relates to stereoscopic viewing devices and more particularly relates to a stereoscopic viewing apparatus having relatively large pupils, high brightness, wide field of view, and a relatively long eye relief.

### BACKGROUND OF THE INVENTION

It is widely recognized that there are significant advantages to a display apparatus that provides the capability for presenting a stereoscopic image. There have been numerous applications for stereoscopic viewing apparatus, including virtual reality systems, medical instrumentation, pilot training and information systems, for example.

A few representative examples of solutions that have been proposed for stereoscopic display are the following:
U.S. Pat. No. 5,757,546 (Lipton et al.) discloses field sequential system designed for immersion stereoscopic viewing using a single display screen;
U.S. Pat. No. 3,463,570 (Ratliff, Jr.) discloses a viewer for stereoscopic display of images from photographs;
U.S. Pat. No. 5,615,046 (Gilchrist) discloses a stereoscopic viewer having a split display screen to provide left- and right-eye images;
U.S. Pat. Nos. 4,982,278 and 4,933,755 (Dahl et al.), disclose a head-mounted device (HMD) with left-and right-eye images produced by a pair of liquid crystal (LC) displays; and
U.S. Patent Application Publication Nos. 2005/0001899 and 2004/0196553 (Banju et al.) disclose boom-mounted stereoscopic viewing apparatus particularly adapted for medical instrumentation.

As this brief partial listing of patent literature suggests, there have been a number of different approaches to the design of stereoscopic viewers utilizing both CRT and LC display devices. Boom-mounted viewers using CRT images were also disclosed by McDowall et al. in “Stereoscopic Displays and Applications” 1990, SPIE Volume 1256, pp. 136-146. An improved approach using LC devices was disclosed by Fisher et al. “Stereoscopic Displays and Virtual Reality Systems II” 1995, SPIE Volume 2409, pp. 196-199. HMD products offering stereoscopic display capabilities are commercially available from companies such as Inition, Ltd. London, UK, for example.

While there have been many proposed solutions for stereoscopic display devices, there are inherent geometrical and ergonomic limitations that are constraints on the optics design. With respect to the viewer, there are a range of values of interocular separation distance and there is a need for some amount of eye relief for viewing comfort, particularly for viewers who wear eyeglasses. For providing the best image quality, there are also requirements for high brightness, large viewing pupils, high resolution, and a wide field of view. There should be minimal crosstalk between left- and right-eye images and minimal interference from ambient light. There should be some allowance for movement of the viewer, with a stereoscopic image that can be viewed over a range of eye positions.

As is well known to those skilled in the art of stereoscopic viewer design, these requirements are often in conflict and some compromise must be achieved. In particular, there are three desirable attributes of a binocular stereoscopic viewer design that will increase the diameter of the eyepieces:
(i) large field of view;
(ii) large viewing pupil; and
(iii) extended long eye relief.

While each of desirable attributes (i), (ii), and (iii) above are best achieved with large diameter lenses, the size of the eyepiece lenses themselves are constrained by interocular separation, so that the diameter of each eyepiece can be no larger than this distance. Because of this ergonomic limitation, various compromises are made. For example, the field of view (i), pupil size (ii) and eye relief (iii) are reduced somewhat. If a large eye relief (iii) is of primary importance, a design must sacrifice both (i) and (ii), providing a smaller field of view and a smaller pupil, all to keep the lens diameters smaller than the interocular separation. Alternately, with an HMD, for example, eye relief (iii) is sacrificed in order to obtain the maximum field of view (i) without a large viewing pupil (ii). For boom-type viewing apparatus, the larger lenses needed to ease these compromises between attributes (i), (ii), and (iii) cannot be fitted together due to interocular separation.

Most HMDs, for example, are limited to providing a viewing pupil no larger than about 12 to 15 mm at best, with eye relief distances usually less than 25 mm. Other types of binocular and boom-mounted systems also are hampered in providing a larger pupil size. Typically, binocular systems, providing a small pupil size typically in the 2-3 mm range, require that the head of the viewer be positioned against a locating mechanical structure in order to fix the viewer's eyes at the correct spot. Binocular systems also provide adjustment for interocular distance.

In the attempt to maximize the field of view, vignetting effects are obtained using conventional approaches for stereoscopic viewer design. Vignetting effects with conventional stereoscopic viewing systems reduce the stereo field of view and have a wider monocular field of view. For example, each eye may see a field of view of 60 degrees, but only 40 degrees is overlapped between each eye.

Thus, although a number of solutions for boom-mounted and other portable stereoscopic viewing systems have been proposed, there is acknowledged to be considerable room for improvement, particularly with respect to enhanced image brightness, wider field of view, higher resolution, larger viewing pupil size, and larger eye relief.

### SUMMARY OF THE INVENTION

It is an object of the present invention to provide an optical apparatus for stereoscopic viewing comprising:
a) a first optical channel comprising:
   i) a first display for generating a first image;
   ii) a first viewing lens assembly for producing a virtual image of said first display and directing the light toward a first viewing pupil;
   wherein at least one optical component of the first viewing lens assembly is truncated along a first side;
b) a second optical channel comprising:
   i) a second display for generating a second image;
   ii) a second viewing lens assembly for producing a virtual image of said second display and directing the light toward a second viewing pupil;
   wherein at least one optical component of the second viewing lens assembly is truncated along a second side;
   iii) a first reflective folding surface disposed between the second display and the second viewing lens assembly to fold a substantial portion of the light within the second optical channel;
   wherein an edge portion of said first reflective folding surface blocks a portion of the light in the first optical channel; and
   wherein the first side of the first viewing assembly is disposed adjacent the second side of the second viewing lens assembly.

It is a feature of the present invention that it adapts the use of lens elements having a diameter in excess of the viewer's interocular distance.

It is an advantage of the present invention that it provides a large viewing pupil, large field of view, and large eye relief in a stereoscopic viewing apparatus.

It is a further advantage of the present invention that it does not require shutter apparatus for providing a stereoscopic display.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a perspective view of a stereoscopic viewing apparatus according to the present invention;

FIG. 2 is a ray diagram showing the optical path for forming the left viewing pupil;

FIG. 3 is a top view showing how the left viewing pupil is formed;

FIG. 4 is a top view showing how the right viewing pupil is formed;

FIGS. 5A and 5B are plan views of viewing pupils 24l and 24r respectively;

FIG. 6 is a plan view of a lens mount according to one embodiment;

FIG. 7 is a perspective view of a lens mount according to one embodiment; and

FIG. 8 is an exploded view of a lens mount according to one embodiment.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

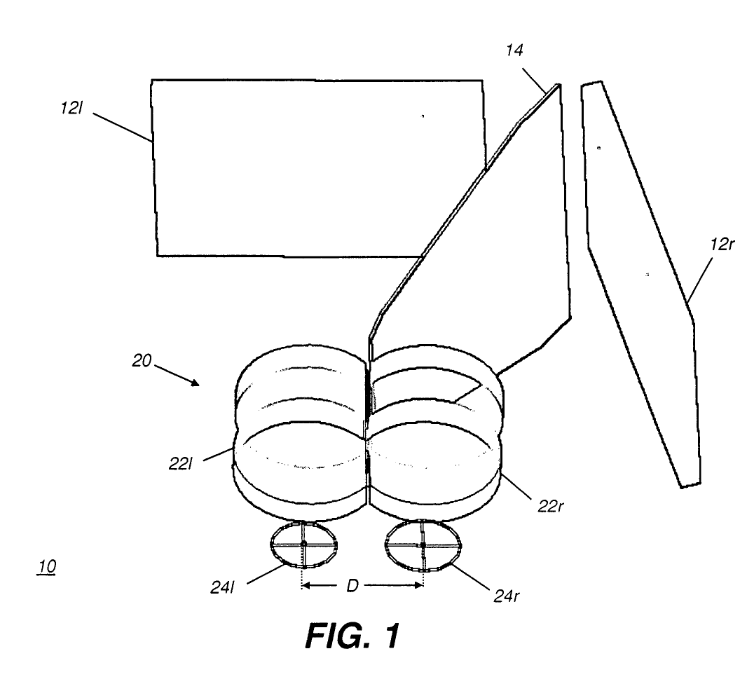

Referring to FIG. 1, there is shown a stereoscopic viewing apparatus 10 in one embodiment of the present invention. Displays 12l and 12r, typically a type of flat-panel display, provide the source left- and right-eye images. A folding mirror 14 or other type of reflective surface redirects the optical path for the right-eye image from display 12r. A viewing optical system 20 has both left and right viewing lens assemblies 22l and 22r, fitted together in a manner described subsequently. Viewing optical system 20 provides left and right viewing pupils 24l and 24r, with centers separated by an interocular distance D.

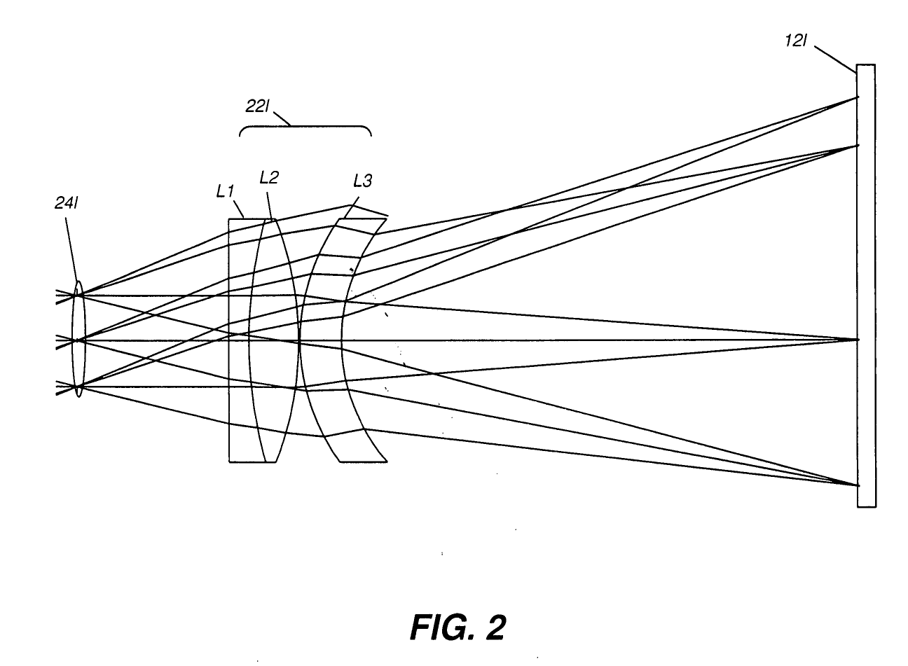

Referring to FIG. 2, there is shown the optical path for forming left viewing pupil 24l. In this embodiment, viewing lens assembly 22l has three components, lens elements L1, L2, and L3 for providing a virtual image of display 12l at viewing pupil 24l. The optical path for forming right viewing pupil 24r is similar, with folding mirror 14 between viewing lens assembly 22r and display 12r. Lenses L1 and L2 may form a cemented doublet, as shown in FIG. 2. In other embodiments, a different arrangement of lens elements L1, L2, and L3 could be used, as well as a different number of lens elements.

In the arrangement of FIG. 1, it can be observed that left and right displays 12l and 12r exceed the size of viewing pupils 24l and 24r. While this size relationship is not required (displays 12l and 12r could be smaller), there can be significant advantages in brightness and resolution when displays 12l and 12r are larger than viewing pupils 24l and 24r.

Displays 12l and 12r can be any of a number of display types. Particularly advantaged for weight and size are flat panel displays such as LC displays, including larger scale LC displays of the thin-film transistor (TFT) type.

Organic LED (OLED) displays are another type of flat panel display that could be suitable. CRT or other types of displays could alternately be used for providing left- and right-eye images.

It can also be observed that at least one optical channel is folded in the apparatus of the present invention. In the arrangement of FIG. 1, the right optical channel is folded. Optionally, the left optical channel, or both left and right optical channels could include a fold mirror. Folding both channels has the advantage of simplifying the electronics in both channels. The display that lies in the folded optical path displays a mirrored image of what is ultimately to be observed by the viewer. Depending on the application, there may also be advantages relative to the depth dimension or form factor of stereoscopic viewing optical system 20.

Viewing Optical System 20

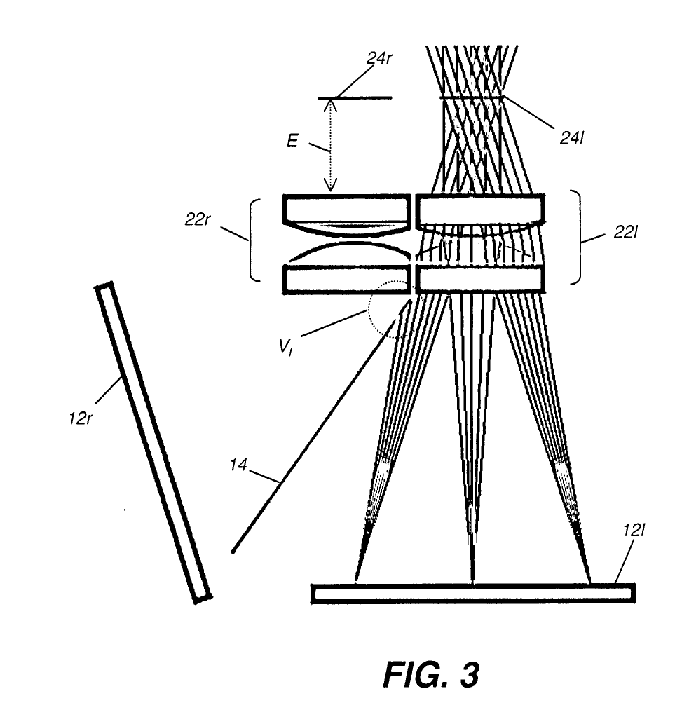

As is shown in FIG. 1, viewing optical system 20 has an arrangement of optical components for forming both left and right viewing pupils 24l and 24r. In order to provide a large viewing pupil 24l, 24r, along with a large field of view and a large eye relief, lens elements L1, L2, L3 within left and right viewing lens assemblies 22l and 22r are relatively large. In one embodiment, these lens elements are larger than 3 inches (76 mm) in diameter. However, this exceeds the interocular separation distance, which is typically in the range of about 60-70 mm for adults. Hence, in order to use lenses of this large size, one or more lens elements L1, L2, L3 of left and right viewing lens assemblies 22l and 22r is truncated along one edge, as is shown in FIGS. 3, 4, 5A and 5B. For left viewing lens assembly 22l, a truncated portion 26l is toward the right side of the aperture. For right viewing lens assembly 22r, a truncated portion 26r is toward the left side of the aperture. As a result of lens truncation, viewing lens assemblies 22l and 22r can be assembled together within a single housing, keeping left and right optical axes properly spaced at the average interocular spacing of about 64 mm.

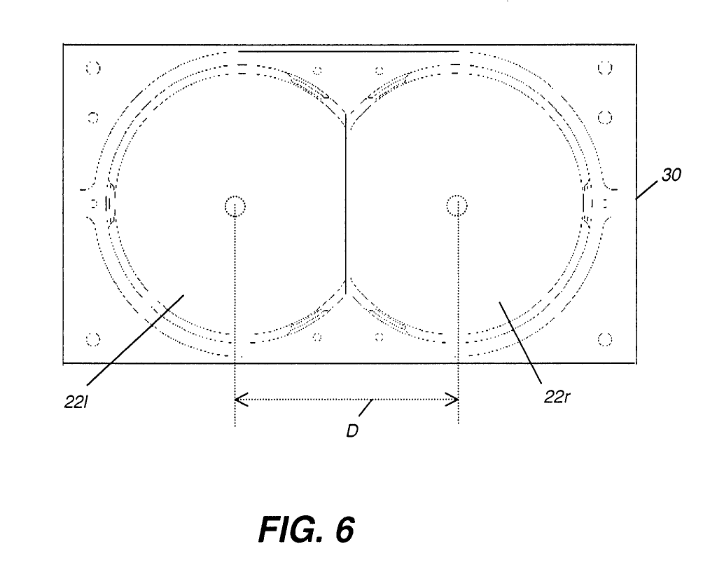

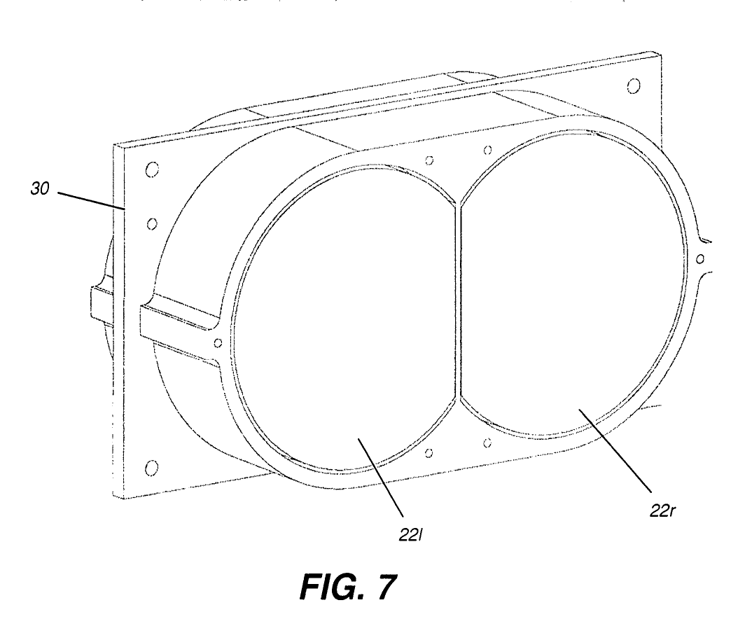

Referring to FIGS. 6, 7, and 8, there are shown a plan view, a perspective view, and an exploded view, respectively, of a lens mount 30 of viewing optical system 20 in one embodiment. Lens mount 30 provides a housing 32 for both left and right viewing lens assemblies 22l and 22r. In this embodiment, lenses L1 and L2 (a cemented doublet in the FIG. 2 embodiment) of left and right viewing lens assemblies 22l and 22r are both of a diameter exceeding the average interocular distance D and are truncated in order to fit together, as was described with reference to FIGS. 3, 4, 5A, and 5B.

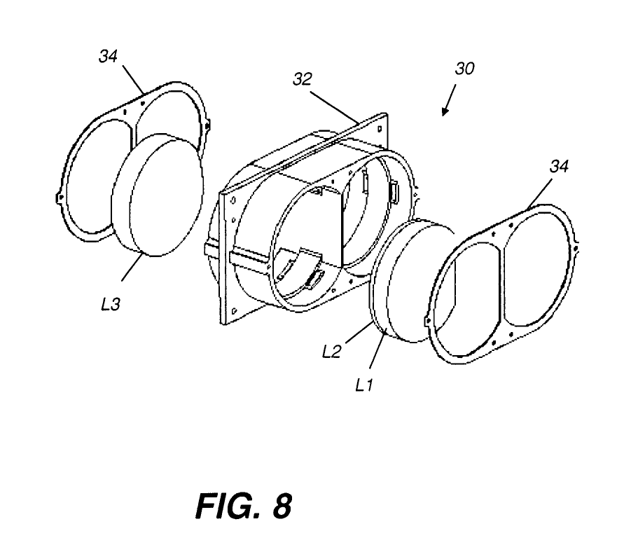

FIG. 6 shows interocular distance D between the respective optical axes of left and right viewing lens assemblies 22l and 22r. The exploded view of FIG. 8 shows assembly details in this embodiment. Lens L3 or other lenses may or may not be truncated, depending on the embodiment. The cemented assembly of lenses L1/L2 and rear lenses L3 are also shown in this exploded view. Housing 32 packages left and right viewing lens assemblies 22l and 22r as one unit. Optional retainers 34 are also shown. It is understood that any number of other possible arrangements of housing 32 and related components could be employed for packaging left and right viewing lens assemblies 22l and 22r in a single assembly.

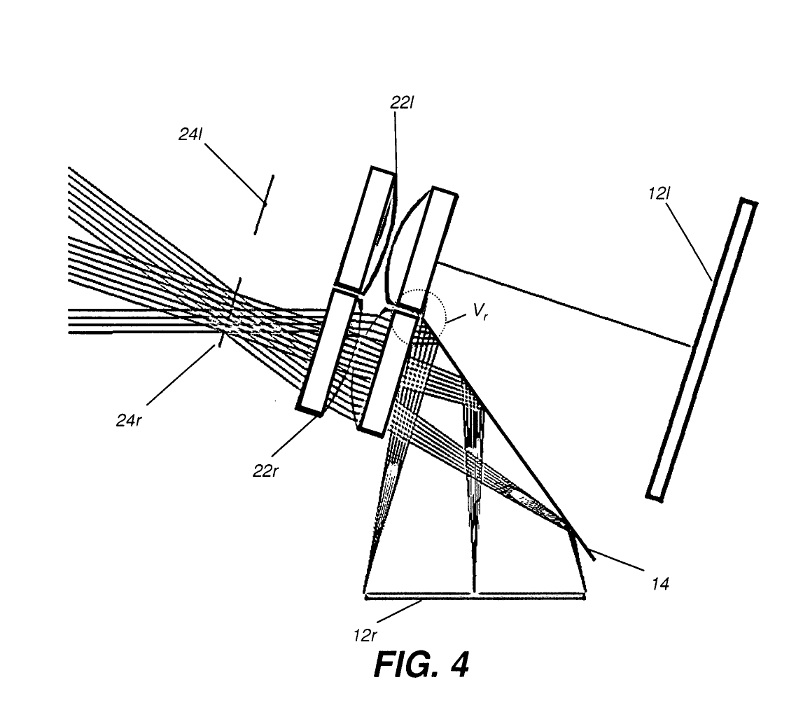

Using relatively large lens elements enables a combination of larger left and right viewing pupils 24l and 24r, larger field of view, and an increased eye relief with respect to conventional boom-mounted and HMD stereoscopic viewing apparatus. FIGS. 3 and 4 show ray diagrams for left and right optical channels, respectively. In FIG. 3, representative rays are shown for the image generated at left display 12l. Due to the position of mirror 14 and the truncation of lens elements shown in FIG. 3, a small amount of the image is effectively vignetted, as called out by dotted circle V₁ in FIG. 3. Similarly, FIG. 4 shows representative rays for the image generated at right display 12r. A small portion of the light from one side of display 12r is not reflected from mirror 14, as called out by dotted circle Vᵣ. These vignetting effects cause some loss of pupil size for these positions in the field of view. However, it is significant to note that these vignetting effects are not in the same part of the stereoscopic field of view for left and right viewing pupils 24l and 24r. With vignetting in this manner, a full stereoscopic image is available over most of left and right viewing pupils 24l and 24r. Where vignetting occurs, the image is still visible to either the left or right eye, but that portion of the field is not stereoscopic.

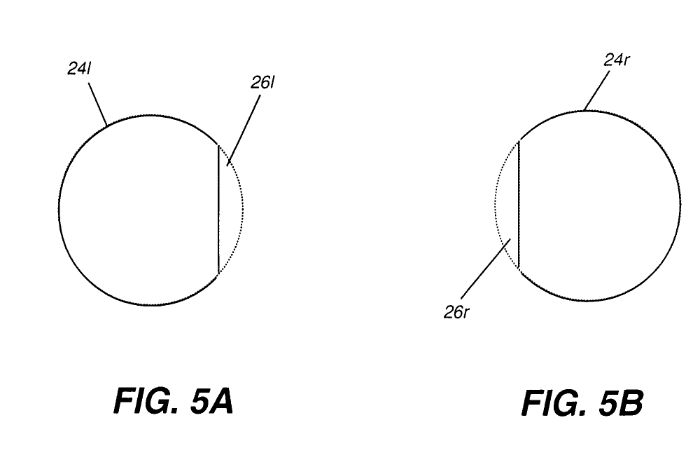

This arrangement achieves a larger effective viewing pupil 24l, 24r, even where some portion of viewing pupil 24l, 24r is not actually stereoscopic. The relative proportion of the field of view that is stereoscopic depends on the position of the viewer's eyes. If the viewer moves too far to the left or too far to the right, the complete field of view is visible, but a proportionately smaller portion of the image is stereoscopic. In effect, the size and shape of viewing pupil 24l, 24r change with the field of view. Stated differently, the entire field of view can be seen in stereo (that is, by both eyes) over some pupil area A and the same field of view can be continued to be seen in mono (that is, by one eye only) over an area outside of area A. This is illustrated in FIGS. 5A and 5B. If the viewer's eye is placed anywhere inside the truncated circular pupil 24l, 24r, the entire image field is visible. If the viewer's eye enters the truncated portion of the pupil (26l for the left eye, 26r for the right eye) then a portion of the field is vignetted. If, for example, the viewer's left eye enters the truncated portion 26l, then the viewer's right eye must be in the non-truncated portion of the right viewing pupil. With this design, the field of view is vignetted only for one eye at any given time, for any given head position.

The apparatus of the present invention provides a stereoscopic display with a comfortable amount of eye relief for the viewer (shown as dimension E in FIG. 3), a large pupil size, and a field of view larger than that provided by conventional boom-mounted stereoscopic displays. In one embodiment of a boom-mounted viewer, for example, eye relief in the 50 mm range can be obtained with a field of view of ±36 degrees from horizontal and a 30 mm viewing pupil.

The apparatus of the present invention is capable of providing very high etendue for boom-mounted stereoscopic viewing. This is particularly true since the dimension of displays 12l and 12r can be larger than the interocular separation distance D.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, there is considerable flexibility in the arrangement of optical components within left and right viewing lens assemblies 22l and 22r. Truncation of these optical components as described with reference to FIG. 1 allows for suitable interocular distance D (understood to be equivalent to the interpupil distance). The arrangement shown in FIGS. 1, 3, and 4 uses mirror 14 in the right optical channel; however, a similar arrangement would allow alternate use of mirror 14 for folding the optical path in the left optical channel, as would be readily apparent to one skilled in the optical design arts. As noted earlier, it would also be possible, in another embodiment, to fold both optical paths.

Thus, what is provided is an apparatus and method for stereoscopic viewing with relatively large pupils, relatively large fields of view, relatively long eye relief, and high brightness.

### PARTS LIST

10 stereoscopic viewing apparatus
12l left display
12r right display
14 mirror
20 viewing optical system
22l left viewing lens assembly
22r right viewing lens assembly
24l left viewing pupil
24r right viewing pupil
26l left truncated portion
26r right truncated portion
30 lens mount
32 housing
34 retainer

1. An optical apparatus for stereoscopic viewing comprising:
a) a first optical channel comprising:
i) a first display for generating a first image;
ii) a first viewing lens assembly for producing a virtual image of said first display and directing the light toward a first viewing pupil;
wherein at least one optical component of the first viewing lens assembly is truncated along a first side;
b) a second optical channel comprising:
i) a second display for generating a second image;
ii) a second viewing lens assembly for producing a virtual image of said second display and directing the light toward a second viewing pupil;
wherein at least one optical component of the second viewing lens assembly is truncated along a second side;
iii) a first reflective folding surface disposed between the second display and the second viewing lens assembly to fold a substantial portion of the light within the second optical channel;
wherein an edge portion of said first reflective folding surface blocks a portion of the light in the first optical channel; and
wherein the first side of the first viewing assembly is disposed adjacent the second side of the second viewing lens assembly.

2. The optical apparatus of claim 1 wherein the first optical channel further comprises a second reflective folding surface disposed between the first display and the first viewing lens assembly to fold a substantial portion of the light within the first optical channel.

3. The optical apparatus of claim 1 wherein at least one optical component of the first viewing assembly has a diameter exceeding 64 mm.

4. The optical apparatus of claim 1 wherein the first and second viewing lens assemblies are mounted within the same housing.

5. The optical apparatus of claim 1 wherein the first display is an LC device.

6. The optical apparatus of claim 1 wherein the first display is an OLED device.

7. The optical apparatus of claim 1 wherein the first display comprises a CRT.

8. The optical apparatus of claim 1 wherein the first viewing pupil is a right-eye viewing pupil.

9. The optical apparatus of claim 1 wherein the first viewing pupil is a left-eye viewing pupil.

10. The optical apparatus of claim 1 wherein the outer diameters of the first and second viewing lens assemblies are larger than the separation distance between the respective optical axes of the first and second lens assemblies.

11. An optical apparatus for stereoscopic viewing comprising:
a) a first optical channel comprising:
i) a first display for generating a first image;
ii) a first viewing lens assembly for producing a virtual image of said first display and directing the light toward a first viewing pupil;
wherein at least one optical component of the first viewing lens assembly is truncated along a first side;
iii) a first reflective folding surface disposed between the first display and the first viewing lens assembly to fold a substantial portion of the light within the first optical channel;
b) a second optical channel comprising:
i) a second display for generating a second image;
ii) a second viewing lens assembly for producing a virtual image of said second display and directing the light toward a second viewing pupil;
wherein at least one optical component of the second viewing lens assembly is truncated along a second side;
iii) a second reflective folding surface disposed between the second display and the second viewing lens assembly to fold a substantial portion of the light within the second optical channel;
wherein an edge portion of said second reflective folding surface blocks a portion of the light in the first optical channel; and
wherein the first side of the first viewing assembly is disposed adjacent the second side of the second viewing lens assembly.

12. The optical apparatus of claim 11 wherein at least one optical component of the first viewing assembly has a diameter exceeding 64 mm.

13. The optical apparatus of claim 11 wherein the first and second viewing lens assemblies are mounted within the same housing.

14. The optical apparatus of claim 11 wherein the first display is an LC device.

15. The optical apparatus of claim 11 wherein the first display is an OLED device.

16. The optical apparatus of claim 11 wherein the first display comprises a CRT.
